(19) United States
(12) Patent Application Publication
(10) Pub. No.: US 2020/0043023 A1
(43) Pub. Date: Feb. 6, 2020

(54) INTEGRATING ELECTRONIC PAYMENTS AND SOCIAL-MEDIA

(71) Applicant: MasterCard International Incorporated, Purchase, NY (US)

(72) Inventors: Jason Alexander Korosec, Morgan Hill, CA (US); Lars Oscar Scofield, Darien, CT (US); Cristobel Kay von Walstrom, Greenwich, CT (US)

(21) Appl. No.: 16/553,740

(22) Filed: Aug. 28, 2019

Related U.S. Application Data
(63) Continuation of application No. 13/601,220, filed on Aug. 31, 2012, now abandoned.

(51) Int. Cl. G06Q 30/02; G06Q 50/00; G06Q 20/10; G06Q 30/06

(52) U.S. Cl. CPC G06Q 30/0201; G06Q 30/0609; G06Q 20/10; G06Q 50/01

(57) ABSTRACT

An operator of a payment network obtains transaction data from a plurality of entities which make payments with the payment network. The operator of the payment network also obtains a plurality of consents from the plurality of entities which make payments with the payment network. The plurality of consents authorize the operator of the payment network to share at least a portion of the transaction data from the plurality of entities which make payments with the payment network with an operator of a social media site. At least portion of the transaction data is made available to the operator of the social media site.

### CROSS-REFERENCE TO RELATED APPLICATIONS

This patent application is a continuation of U.S. patent application Ser. No. 13/601,220 filed Aug. 31, 2012 entitled “INTEGRATING ELECTRONIC PAYMENTS AND SOCIAL-MEDIA.” The complete disclosure of the aforementioned U.S. patent application Ser. No. 13/601,220 is herein expressly incorporated by reference in its entirety for all purposes.

### FIELD OF THE INVENTION

The present invention relates generally to electronic commerce, and, more particularly, to electronic payment systems.

### BACKGROUND OF THE INVENTION

The use of credit cards, debit cards, pre-paid cards, and similar non-card payment devices (e.g., appropriately configured smart phones) has become ubiquitous. People may use such cards and devices for many different types of purchases, including goods and/or services, and ranging from small to major purchases.

Social media includes web-based and mobile technologies used to turn communication into interactive dialogue. Examples include magazines, Internet forums, weblogs, social blogs, micro-blogging, wikis, podcasts, photographs or pictures, video, rating and social bookmarking. One particularly popular type of social media is the social networking site (e.g., Facebook).

### SUMMARY OF THE INVENTION

Principles of the present invention provide techniques for integrating electronic payments and social media. An exemplary embodiment of a method, according to one aspect of the invention, includes the steps of obtaining, by an operator of a payment network, transaction data from a plurality of entities which make payments with the payment network; obtaining, by the operator of the payment network, a plurality of consents from the plurality of entities which make payments with the payment network, the plurality of consents authorizing the operator of the payment network to share at least a portion of the transaction data from the plurality of entities which make payments with said payment network with an operator of a social media site; and making the at least portion of the transaction data available to the operator of the social media site.

Aspects of the invention contemplate the method(s) performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein.

One or more embodiments of the invention can provide substantial beneficial technical effects. One non-limiting example is the linkage of transactional data to social media data for enhanced security—a transaction in a location that does not correlate with contemporaneous social media data may suggest a lost or stolen card or an attempt to commit fraud by an unscrupulous individual.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a general example of a payment system that can implement techniques of the invention;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers;

FIG. 3 depicts exemplary interaction of a consumer with a payment network operator and a social media site, via a network, according to an aspect of the invention;

FIG. 4 depicts an exemplary consumer experience, including enrollment, configuration, opt-in, and publication, according to an aspect of the invention;

FIG. 5 depicts more details of exemplary configuration and opt-in processes, according to an aspect of the invention;

FIG. 6 presents a screen shot of exemplary consumer enrollment, at a social media web site's payments settings page, according to an aspect of the invention;

FIG. 7 presents a screen shot of exemplary consumer enrollment, at a social media web site's payment method page, according to an aspect of the invention;

FIG. 8 presents a screen shot of exemplary consumer enrollment, at a social media web site's timeline page, according to an aspect of the invention;

FIG. 9 depicts an exemplary enrollment and publication data flow, according to an aspect of the invention;

FIG. 10 depicts an exemplary “low integration” embodiment, according to an aspect of the invention;

FIG. 11 depicts an exemplary “high integration” embodiment, closely integrated with an electronic wallet, according to an aspect of the invention;

FIG. 12 is a block diagram of an exemplary computer system useful in one or more embodiments of the invention; and

FIG. 13 is an exemplary software architecture diagram.

### DETAILED DESCRIPTION OF PREFERRED EMBODIMENTS

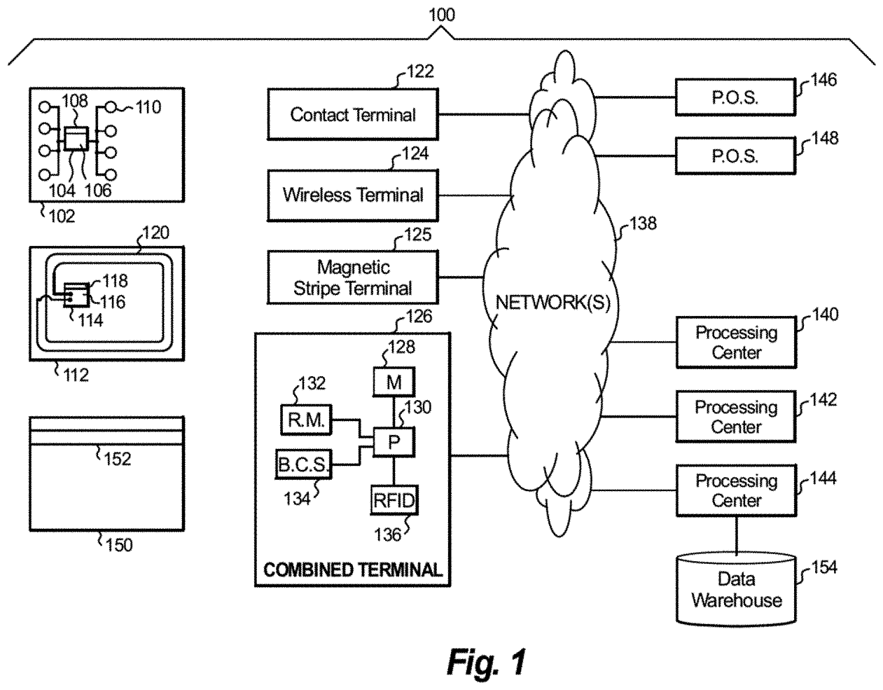

Attention should now be given to FIG. 1, which depicts an exemplary embodiment of a system 100, according to an aspect of the invention, and including various possible components of the system. It should be noted that while presentation of physical cards to terminals is described, one or more embodiments of the invention can also be used in connection with card-not-present transactions as well (e.g., Internet commerce transactions). System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. Other types of devices used in lieu of or in addition to “smart” or “chip” cards 102, 112 could include a conventional card 150 having a magnetic stripe 152, an appropriately configured cellular telephone handset, and the like. Indeed, techniques can be adapted to a variety of different types of cards, terminals, and other devices, configured, for example, according to a payment system standard (and/or specification).

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions or units 108, 118 can store the operating system of the cards 102, 112. The operating system loads and executes applications and provides file management or other basic card services to the applications. One operating system that can be used is the MULTOS® operating system licensed by MAOSCO Limited (MAOSCO Limited, St. Andrews House, The Links, Kelvin Close, Birchwood, Warrington, WA3 7PB, United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

As noted, cards 102, 112 are examples of a variety of payment devices that can be employed. The primary function of the payment devices may not be payment, for example, they may be cellular phone handsets. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more method steps. The applications can be, for example, application identifiers (AIDs) linked to software code in the form of firmware plus data in a card memory such as an electrically erasable programmable read-only memory (EEPROM). Again, note that “smart” or “chip” cards are not necessarily required and a conventional magnetic stripe card can be employed; furthermore, as noted above, one or more embodiments are also useful in the context of card-not-present transaction, including Internet transactions.

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (for example, a virtual private network, such as the BANKNET® virtual private network (VPN) of MasterCard International Incorporated of Purchase, N.Y., USA). More than one network could be employed to connect different elements of the system. More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 140, 142, 144 can include, for example, a host computer of an issuer of a payment device (or processing functionality of other entities discussed in other figures herein, such as processing capability of an operator of a payment network).

Many different retail or other establishments, as well as other entities, generally represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

Again, conventional magnetic stripe cards 150 can be used instead of or together with “smart” or “chip” cards, and again, in addition to physical cards and other physical payment devices, one or more embodiments are also useful in the context of card-not-present transactions, such as Internet transactions.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128, which then contactlessly transmits the electronic data to the proximity IC chip in the card 112 or other wireless device. Magnetic stripe cards can be swiped in a well-known manner. Again, in some instances, the card number is simply provided via web site, in a card-not present transaction, or the like.

One or more of the processing centers 140, 142, 144 can include a database such as a data warehouse 154.

In Internet or other card-not-present transactions, the card or other device is not presented to terminal 122, 124, 125, or 126. Rather, appropriate card information (e.g., primary account number (PAN), cardholder name, cardholder address, expiration date, and/or security code, and so on) is provided to a merchant by a consumer using a web site, telephone, or the like. The merchant then uses this information to initiate the authorization process. Some embodiments employ an e-wallet, which is useful, for example, in connection with card-not-present Internet transactions.

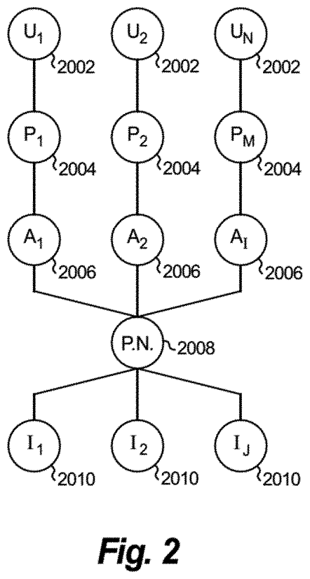

With reference to FIG. 2, an exemplary relationship among multiple entities is depicted. A number of different users (e.g., consumers such as on-line shoppers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the cardholder 2002 pays for the purchase and the merchant 2004 submits the transaction to the acquirer (acquiring bank) 2006. During Internet commerce, for example, the cardholder may simply provide the card number, expiration date, security code, and/or other pieces of data described above to the merchant, who prepares an authorization request based upon same without actually seeing the physical card. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

It will be appreciated that the network 2008 shown in FIG. 2 is an example of a payment network configured to facilitate transactions between multiple issuers and multiple acquirers, which may be thought of as an “open” system. A wide variety of other types of payment networks can be used. For example, some embodiments of the invention may be employed with proprietary or closed payments networks with only a single issuer and acquirer; with mobile networks; and/or with various types of electronic wallet services in conjunction with a suitable payment network.

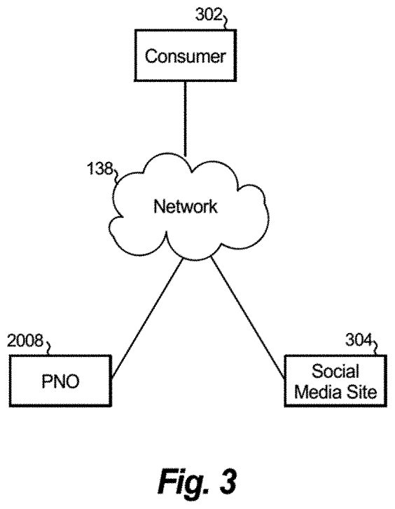

Referring to FIG. 3, one or more embodiments empower the consumer 302 to socialize (publish and share) his or her payment transactions on a social media web site 304 using social media web site sharing venues, such as wall, timeline, places, merchant pages, and the like. Non-limiting examples of social networking services include FACEBOOK® (registered mark of Facebook Inc., Menlo Park, Calif., USA) and GOOGLE+® (registered mark of Google Inc., Mountain View, Calif., USA). The payment transactions may be carried out, for example, with the aid of an operator 2008 of a payment network (PNO). The entities may communicate via one or more networks such as network 138. PNO 2008 is generally representative of payment network operators, regardless of whether they connect multiple issuers and acquirers as shown in FIG. 2. In one or more embodiments, after initial enrollment, configuration and opt-in, the consumer may take further action to socialize his or her payments transactions (but is not obligated to do so).

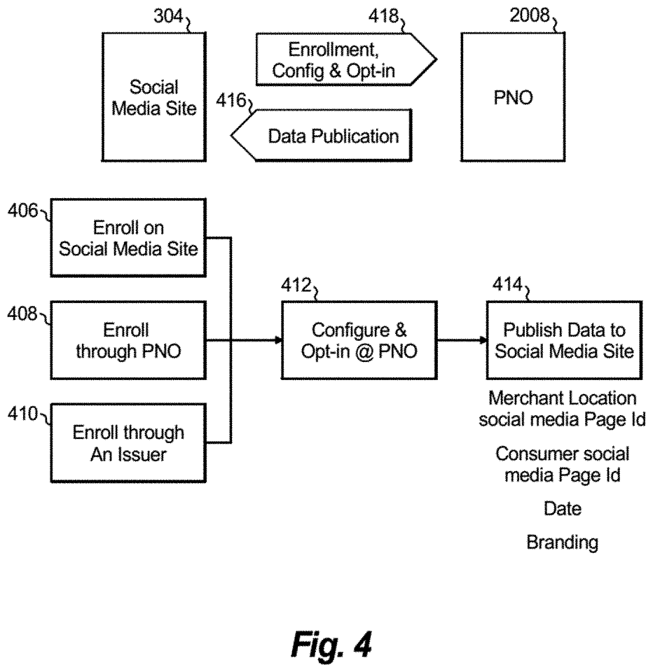

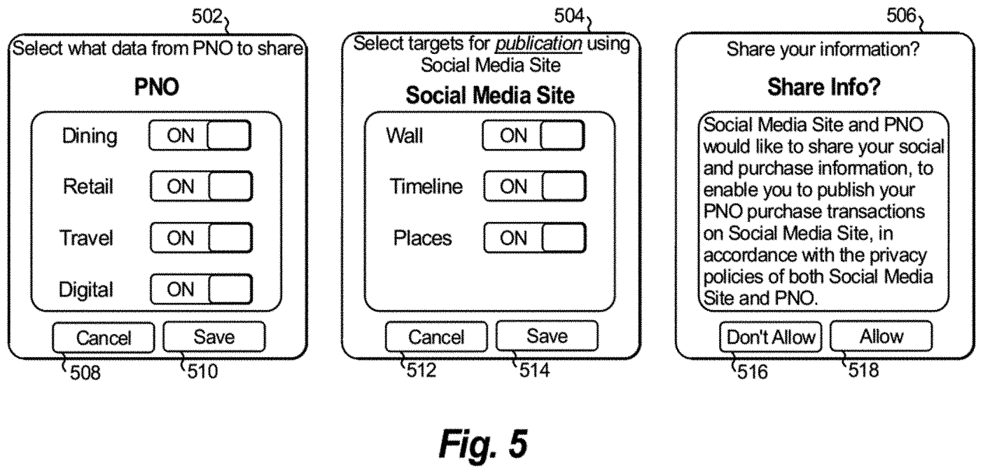

Referring now to FIG. 4, in one or more embodiments, consumer processes include enrollment, as at 406, 408, 410; and use, discussed further below. In enrollment, consumer 302 decides to participate. This may involve, for example, agreeing to legal terms with PNO 2008 and the operator of social media site 304 (SMSO). In general, this may involves a unified process or two separate processes, one with the operator of social media site 304 and one with PNO 2008. The consumer may agree, for example, to allow PNO 2008 to push his or her payment data to SMSO 304 and to allow others to see this data on site 304. Note that, for convenience, reference character 304 is used to refer to the site and its operator and reference character 2008 is used to refer to the network and its operator. Attention should also be given to FIG. 5. Partial screen shot 506 depicts a query box with response buttons 516, 518 where the consumer may elect whether he or she wishes to opt-in to information sharing.

As seen at 502, in addition to the opt-in process, the consumer may decide to configure what subset of transactions he or she wishes to be posted to site 304. In the non-limiting example of FIG. 5, these include DINING, RETAIL, TRAVEL, and DIGITAL. The user is allowed to turn each category on or off with an associated button (not separately numbered to avoid clutter). The final choices can be saved with button 510 or cleared to start again with button 508. The user may wish to publish all or only part (a subset) of his or her transactions. View 502 represents one logical grouping of transactions by types of categories, from which the user can pick which categories he or she wants to have published. Other categories, additional categories, or other methods of selection could be employed in other embodiments. For example, the consumer may want to share restaurants and allow PNO 2008 to publish date, time, and location of any restaurant anywhere in the world. This could also include, for example, an attached map or other application or feature so people can find the restaurant. An opportunity could also be afforded for the cardholder to enter a review of his or her dinner experience. A link could be provided to other sources of reviews for the restaurant on the Internet (for example, the FOURSQUARE® location-based social networking web site (registered mark of Foursquare Labs, Inc., New York, N.Y., USA). Alternatively, instead of restaurants, the user may elect to publish travel-related transactions. This aspect might also include restaurants if they are identified as related to travel. Some people might even elect to publish their grocery shopping. In any event, the consumer configures the type of data he or she wants to share.

As shown at screen shot 504, the user may also be afforded an opportunity related to the target for publication at the site 304. Purchase data to be shared can be shared in a variety of contexts such as a wall, a timeline, or places. The user is allowed to turn each category on or off with an associated button (not separately numbered to avoid clutter). The final choices can be saved with button 514 or cleared to start again with button 512.

In the enrollment process, consumers may interact with site 304, for example, by calling up an application program interface (API) over network 138 such as the Internet; that API enables the kind of interaction just described.

As used herein, the “Internet” capitalized refers to a global system of interconnected computer networks that use the standard Internet protocol suite (often called TCP/IP) to serve users worldwide; the Internet is a network of networks. On the other hand, the term “internet” when not capitalized refers to any system of interconnected computer networks, including the Internet and other internetworks.

Any of the options shown in FIG. 5, or similar options, can be changed over time. That is to say, the consumer may change his or her preferences as to what types of transactions will be shared, where they will be shared, or whether they are to be shared at all; or the options offered to the user (e.g., actual categories that can be selected from) may change over time, or both. In one or more embodiments, these aspects are enabled and controlled via a technology connection between SMSO 304 and PNO 2008; for example, by API or the like. In one or more embodiments, an application on site 304 invokes an API to the PNO's infrastructure. This API displays the consumer choices. As the consumer makes selections within site 304, those are piped back to PNO 2008. The selections can, for example, be saved in a data warehouse 154 at that time.

In at least some instances, Internet technologies such as transmission control protocol/internet protocol (TCP/IP) are employed for communication between the consumer 302 and site 304 and between site 304 and PNO 2008. APIs can be written, for example, in one of the third generation languages such as C++, Perl, JSON, or the like.

Thus, referring back to FIG. 4, enrollment can be carried out in a variety of ways; for example, at the site 304, as shown at 406; via the PNO 2008, as shown at 408; or via an issuer 2010, as shown at 410. As alluded to above, there may be some payment data that will not be shared even if the consumer does consent; for example, health care transactions. PNO 2008 might deem it to be against policy or otherwise inappropriate. Thus, consumer 302 may be afforded many options but some may be restricted for legal or policy reasons or the like. Stated in another way, there is preferably no sharing without the consumer's consent, and some data may not be appropriate to share even with the consumer's consent. As seen at 412, configuration and opt-in may be carried out, for example, via PNO 2008. As shown at 414, once all is in readiness, publication of data to the site 304 may commence. Such data can include, for example, the merchant's location, the merchant's social media page identifier, the consumer's social media page identifier, the date, and branding information (i.e., what type of card was used for the transaction, also referred to as card type or logo; or indeed any other brand in the payment chain—merchant brand, other payment intermediaries (e.g., wallet providers), and the like). In general, different amounts of information may be published. In some cases, less information could be provided; for example, only the merchant's social media page identifier, the consumer's social media page identifier, the date, and branding information. On the other hand, in other cases, more information could be provided; for example, a full transaction stream such as merchant identifier (non-limiting examples include merchant ID (MID), card acceptor ID, and acquiring ID), transaction identifier, date, time, merchant category code, amount, merchant's name and address, consumer's information, as well as the information already mentioned.

Thus, as shown by arrows 416, 418, in some embodiments, enrollment, configuration, and opt-in may be effectuated (or otherwise facilitated) by PNO 2008 while publication takes place at site 304.

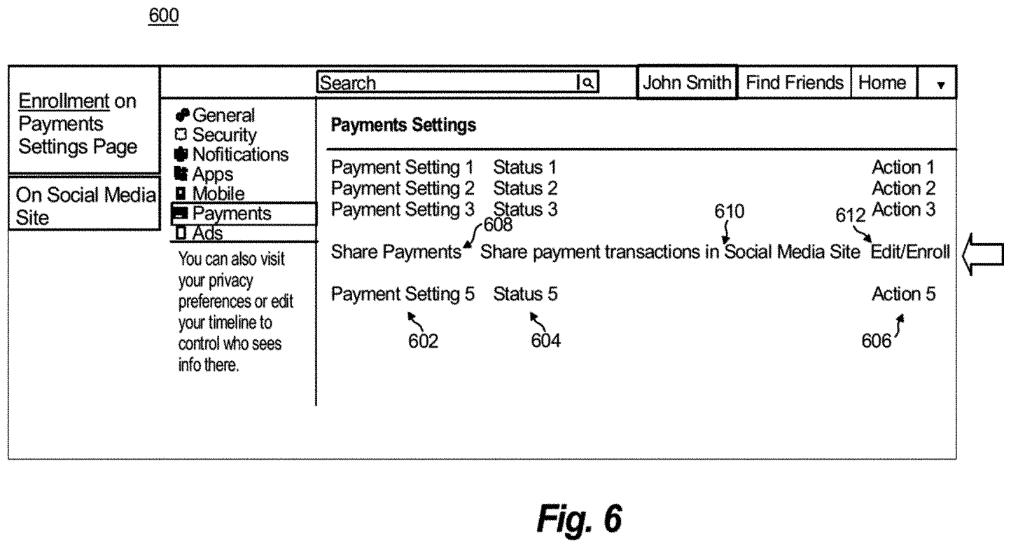

Further non-limiting exemplary aspects of enrollment will now be discussed with respect to FIGS. 6-8. FIG. 6 presents a screen shot of exemplary consumer enrollment at a social media web site's payments settings page 600. Page 600 may afford the user a plurality of payments settings 602 shown generically as payments settings 1 through 3 and 5; examples include a balance, a purchase history, different payment methods available, and preferred currency. The status of the different settings may be shown at 604 (e.g., value of the balance, what the current preferred currency is). Available options may be shown at 606 (e.g., view history, change preferred currency). One of the settings could be a “share payments” option 608, shown in lieu of generic option 4. As indicated in the status portion 610, this setting 608 allows sharing payments transactions on site 304. As seen at 612, the available actions are enrolling or editing.

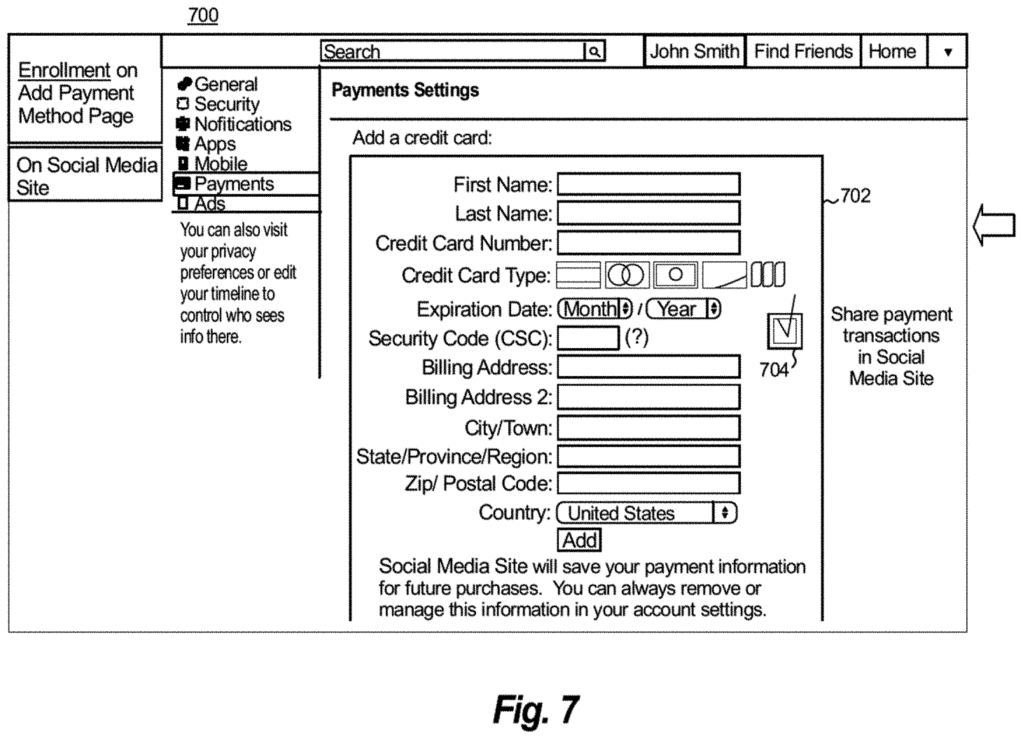

FIG. 7 presents a screen shot of exemplary consumer enrollment at a social media web site's payment method page 700. A dialog region 702 allows the user to enter a new credit card or the like, or edit an existing one. As part of the dialog, the user is allowed to check a box 704 to opt-in to sharing of payment data with site 304.

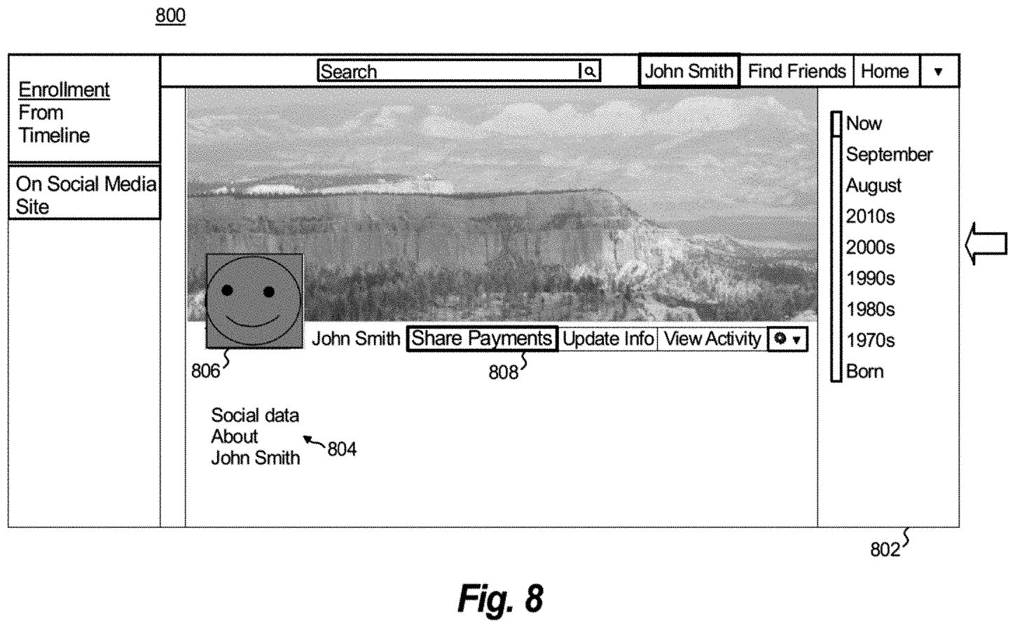

FIG. 8 presents a screen shot of exemplary consumer enrollment at a social media web site's timeline page 800. Page 800 can include, for example, an image 806 of the user (shown as a generic “smiley face” for illustrative convenience); various social data about the user, as at 804 (e.g., professional data, family data, educational data); and a timeline 802. A link 808 to “share payments,” which links to one or more enrollment/opt-in screens, may also be provided.

It will be appreciated that one or more embodiments benefit the consumer by allowing SMSO 304 to enhance its user experience by enabling its members to socialize (publish) selected payment transaction data to their profiles.

Various types of data feeds can be employed. In some instances, a consumer's raw transaction data (with appropriate consents) can be provided from PNO 2008 to site 304. In general, options could include, for example, raw data feed; limited data feed; or creation of a private application (e.g., customized based on interests, age, organization membership, etc.) by PNO 2008. Furthermore in this regard, in one or more embodiments, the consumer has the ability to include or exclude whatever types of data are to be shared (publicly or privately) with a social media site. For example, the consumer may want to share what restaurants he or she patronizes, and his or her comments about the merits of those restaurants (or may only want to share restaurant data for restaurants in a certain geographic location); or may want to share airline ticket information. However, the consumer may not wish to share data on grocery stores, gasoline filling stations, and so on. A variety of options may be provided to enable the desired filtering, such that the data feed to the social media site includes only that information which the consumer wishes to share. Data could also be obtained, for example, from other providers, such as issuers 2010, acquirers 2006, processors (entities that carry out processing on behalf of other entities such as issuers), or the like. Further examples of data that the consumer might choose to share include itinerary data, item level data (e.g., SKU or stock keeping unit), and so on. These data feeds may be obtained from a variety of sources, in one or more embodiments, including third parties other than the payment network operator (issuers, acquirers, other data providers with itineraries, folio-level data, SKU-level data, and the like).

Non-limiting examples of data that can be exchanged include Merchant's Social Media Site Page ID; Consumer's Social Media Site Page ID; Transaction Date; and Associated Logo (e.g., logo of the card used to make the transaction, or indeed of any other brand in the payment chain—merchant brand, other payment intermediaries (e.g., wallet providers), and the like)). PNO 2008 may be provided with access to features of site 304, such as a social graph, for enrolled consumers. In some cases, SMSO 304 and PNO 2008 host an enrollment and de-enrollment process with consumer consents; while PNO 2008 hosts the configuration. Opt-in consent may be obtained in a variety of ways. For example, in some instances, SMSO 304 obtains two opt-in consents from cardholders (one for the benefit of the SMSO; one for the PNO).

Appropriate usage limits are preferably placed on use of the published data. Appropriate age limits are preferably enforced on those enrolling for data sharing. Of course, all applicable laws, rules, regulations, policies and procedures with respect to age of consumers, privacy, and the like should always be fully complied with.

In some instances, a payment-source specific logo is supported by SMSO 304; for example, a MASTERCARD logo is displayed in connection with MasterCard card purchases, a VISA logo in connection with VISA card purchases, and so on.

Various appropriate arrangements can be made between SMSO 304 and PNO 2008 with regard to advertising placement, advertising revenue sharing, offering of products of PNO 2008 to merchants or other parties signed up with site 304, and so on.

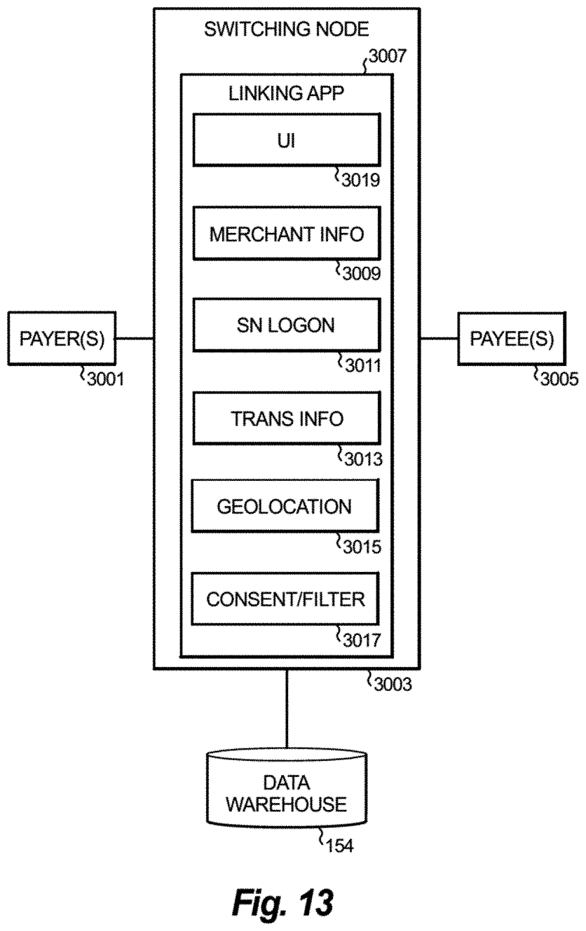

As noted, in some instances, PNO 2008 develops a suitable application which accesses programming of SMSO 304 via appropriate APIs. Further details are provided below in connection with the description of FIG. 13.

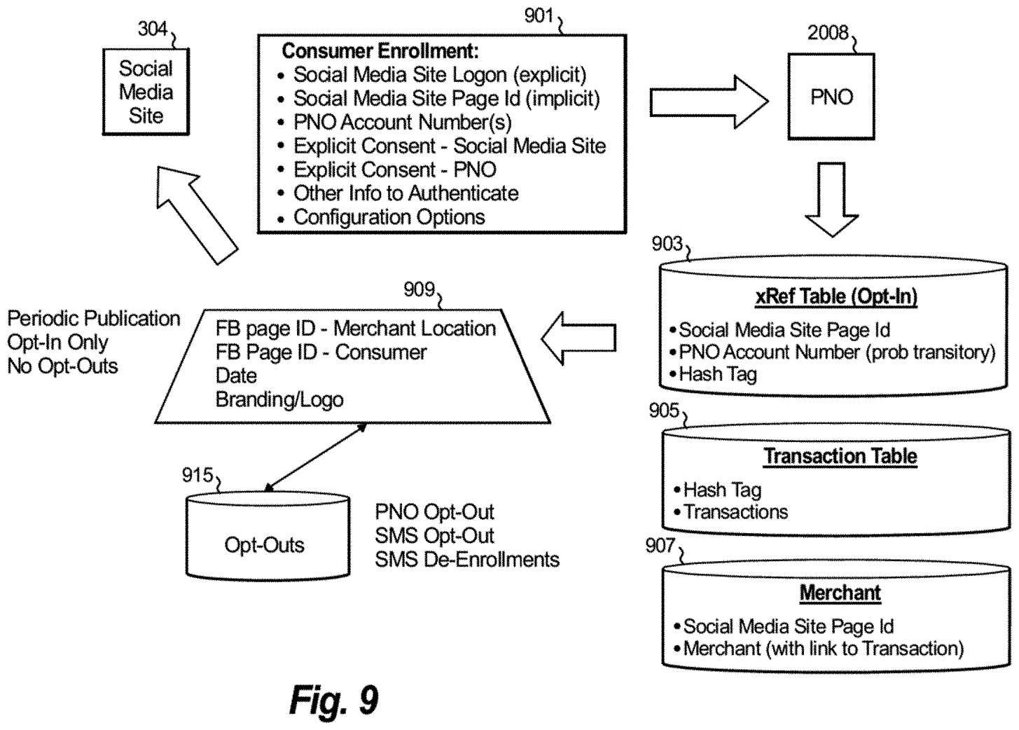

Referring now to FIG. 9, consumer enrollment 901 can include information provided to the PNO 2008. Such information can include the Social Media Site Logon (explicit—consumer opts in and links to one or more payment card numbers), Social Media Site Page ID (implicit—there are typically page IDs associated with the consumer's social media site page and with every application—these are typically not explicitly recognized by the consumer—these are used to publish material to the social media site and may be a portion of a URL and/or a link to a database of the social media site), PNO Account Number(s) (PANs of one or more pre-registered cards for which it is desired to share transaction data), and the like. In one or more embodiments, explicit consumer consent is obtained at the Social Media Site 304 and/or a site of the PNO 2008, for the benefit of both the SMSO and PNO. Other information may be gathered for authentication purposes (authentication process to confirm that the person providing the consent is who he or she purports to be; e.g., identity, password, optionally multifactor authentication, and the like). The above-discussed configuration options can be saved.

The PNO 2008 may set up various data structures as shown at 903, 905, and 907. Data structure 903 is an opt-in cross reference table. It includes, for those who have opted in, the social media site page identifier, the PNO account number, and a suitable hash tag (anonymous/secure identifier so PAN can't be mis-used). Transaction table 905 includes, for each aforementioned hash tag, the pertinent transaction data. Merchant data structure 907 includes, for each merchant, the merchant's social media site page identifier and a link to the transaction(s) using appropriate merchant and transaction identifiers to link the card account(s) to the merchant(s) as discussed above. In one or more embodiments, the data in tables 903, 905, 907 is distilled down to a subset 909, including the merchant's social media page identifier, the consumer's social media page identifier, the date, and branding information, as discussed above. This filtering process is also informed by interaction with opt-out database 915. Information 909 is only published to site 304 after removing data from anyone who has opted out or de-enrolled via site 304 or PNO 2008. Database 915 can be populated, for example, via a web site or call center that allows consumers, and optionally, payment networks, merchants, and any other participants, to provide or withhold participation consent in whole or in part. It should be noted that the terminology “opt out” is not meant to suggest that personal data is ever employed without an affirmative consent from the person who is the subject of the data—indeed, it is preferred that no sharing occurs without the consent of the consumer or other individual.

Thus, following enrollment, PNO 2008 may set up a data warehouse 154 including a variety of filters which will collect transactions. In other words, when the consumer enrolls, the enrollment process effectively creates a profile. That profile is put into the data warehouse, preferably in a special section thereof, and is used to filter transactions. The filtered transactions are collected and provided to the SMSO in the SMSO's environment. That is, data that meets the criteria is served up and published to the SMSO in one of a variety of ways. During enrollment, as noted, the consumer may select how he or she wants his or her data shown on site 304. One non-limiting example is publishing transactions to a so-called timeline or wall (collection of the photos, stories, and experiences that tell an individual's story); another example is publishing transactions to a so-called circle (data structure which enables users to organize people into groups for sharing). In some instances, with suitable consent, the data is also published to a data warehouse associated with the SMSO 304; for example, to allow the SMSO to use it to generate advertisements, offers, or the like.

It is worth distinguishing the ongoing publication processes from the subsequent use processes (even though publication and use may be happening simultaneously).

A variety of techniques can be used to publish data to the relevant section(s) of social network(s). In some instance, utilizing appropriate profile data, data is pulled from the data warehouse 154 of the PNO 2008 and pushed to the target market (site 304) over the Internet. In some instances, an RSS type feed to site 304 can be employed or an API of the SMSO is used to push the data onto site 304. Refer to discussion of FIG. 13 below.

Considering again the configuration aspect, amending the configuration may be carried out in some instances when change is desired. For example, the user may not want to publish all restaurants any more, just travel-related transactions. The user can call back the enrollment process and modify the way his or her configuration is working to reflect the desired items to share. This can include, for example, deleting all prior posts; keeping old posts but not sharing new posts going forward; stopping sharing altogether and deleting everything; or keeping on sharing but using new filters. Reconfiguration is essentially the same as enrollment except the user modifies what he or she did previously and has the option to delete data going backwards.

A variety of subsequent uses may be made of the data, subject, of course, to appropriate consent. In this regard, tying together social data with payment data is believed to be quite significant and advantageous. One suitable subsequent use of data is targeted advertising. For example, based on the subject's purchasing history, it may be determined that the subject is interested in travel but not hair care products; further, it may be determined, based on the history, that the subject is interested in both business and family travel. Social commentary of the subject may also be employed in targeting. For example, suppose the subject has commented favorably on Airline B but unfavorably on Airline A. An offer could be provided related to Airline C which draws a fruitful comparison to Airline B or a significant distinction from Airline A. Other potential subsequent uses include utilizing the data in follow-on processes such as tax preparation (e.g., integration with the social media site helps to identify expenditures as business-related or personal); providing advice (e.g., making user aware of offers, suggestions, or alerts, based on past single data points and/or past patterns), etc.

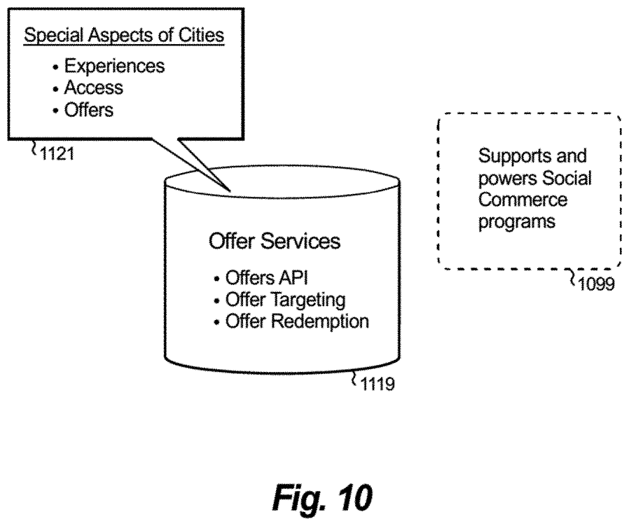

FIG. 10 shows an exemplary “low integration” embodiment wherein the PNO 2008 and SMSO 304 are relatively less integrated than in the high integration approach discussed below. PNO 2008 may provide offer services 1119. This may be in the form of a web service such as a web API or the like. A database of offers may be maintained by service 1119 together with suitable business logic for offer targeting and offer redemption. As shown at 1121, non-limiting examples of offers include special deals such as special experiences, special access, or special offers; the same may be linked to a particular city, other geographical area, or by some other criteria. In the low integration approach, as seen at 1099, PNO 2008 supports and powers social commerce programs such as special travel-related offers, deals, and experiences; shopping-related blogs or web sites; and so on.

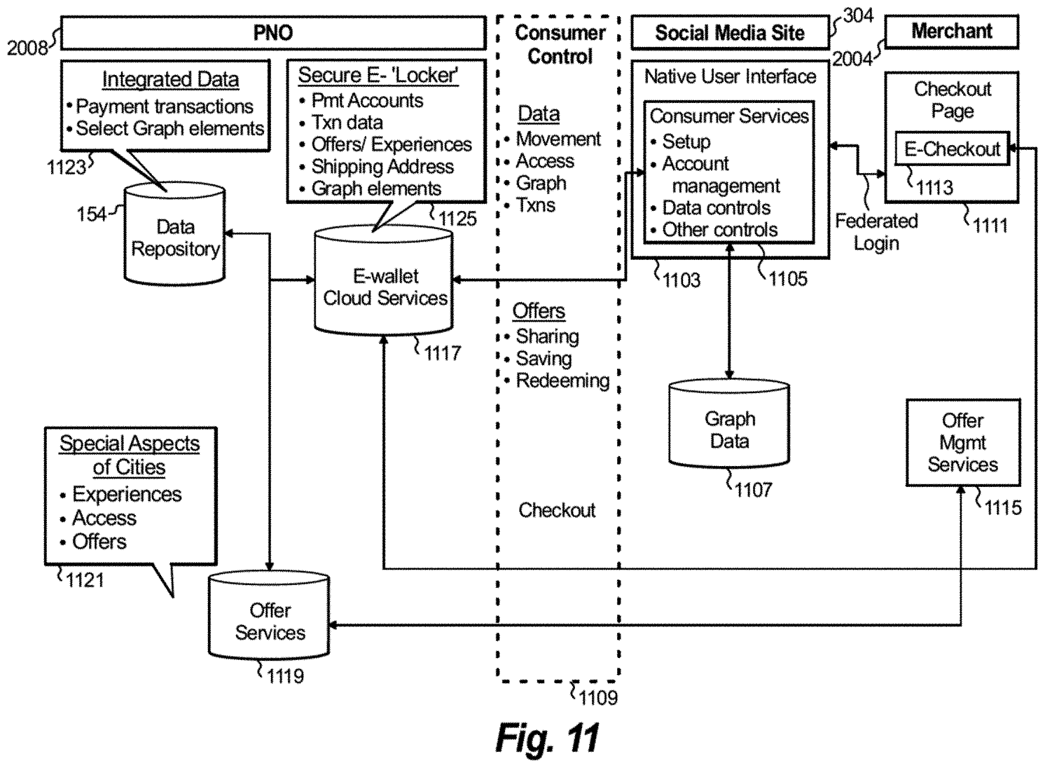

FIG. 11 depicts an exemplary “high integration” embodiment, closely integrated with an electronic payments wallet. Furthermore in this regard, with the growth of Internet commerce, the electronic wallet (e-wallet), also known as a digital wallet, has been developed. An e-wallet provides consumers with a secure and convenient way to pay for purchases from accepting on-line merchants. Upon registration, consumers may store their card, billing and shipping information on a site hosted by a suitable entity, and may access that information to pay conveniently and securely across participating merchants. The e-wallet platform may, in some instances, deliver additional security with the use of “virtual” account numbers to mask cardholders' real information. The consumer enters one or more debit and/or credit cards or the like in the e-wallet and makes payments on line. Use of an e-payments wallet inside site 304 enables data sharing in a native way. In at least some instances, instead of back and forth communications using APIs, at least some aspects of one or more embodiments are implemented within and/or facilitated by a suitable e-wallet.

With continued reference to FIG. 11, PNO 2008 may provide an e-wallet; for example, as a cloud computing service, as shown at 1117. Within e-wallet 1117, there will typically be a wallet of different credit, debit, or charge cards, e.g., MASTERCARD® cards (registered mark of MasterCard International Incorporated, Purchase, N.Y., USA); VISA® cards (registered mark of VISA International Service Association, Foster City, Calif., USA); DISCOVER® cards (registered mark of Discover Financial Services Corporation, Riverwoods, Ill., USA); or AMERICAN EXPRESS® cards (registered mark of American Express Company, New York, N.Y., USA). When the consumer configures the wallet for transactions (for example, with a brand of payment card corresponding to PNO 2008, such as MASTERCARD brand) he or she configures exactly which types of transactions he or she wants to share in the SMSO's social graph or the like. In this embodiment, the wallet can implement the above-discussed configuration aspects. Data repository 154 can be implemented, for example, as a data warehouse of PNO 2008. As seen at 1123, it includes all the payment transactions and adds any of the social graph elements 1107 (or similar social data) being discovered form the social network 304. Payments locker 1125 is where the different payment accounts are located. It also references back to the transaction data in the data repository 154 so each individual consumer can see old transaction data. Offers associated with the transaction data are also present in the locker 1125, including desired shipping addresses or the like. The payments locker 1125 can be provided, for example, by electronic wallet cloud-based services 1117. The offers and experiences come from offer services 1119 as discussed above. Examples of offers including special deals such as special experiences, special access, or the like were discussed above in connection with block 1121. As the various offers are developed, there will be various associated parameters and the like. For example, an exemplary parameter could be the fact that the consumer shopped at a big box retailer and purchased lumber; in response, the consumer receives an offer for a portable electric drill. Conversely, if the consumer did not shop at such a store, such an offer is not generated. Offer services database 1119 is thus a database of many different kinds of offers that are available to particular consumers. The offers are matched against various criteria (for example, in data repository 154) to determine if the given consumer is eligible for the particular offer.

In the exemplary embodiment of FIG. 11, everything in the column under PNO 2008 is held, managed, and controlled by PNO 2008, and is preferably secured using appropriate security techniques. Now consider column 1109 labeled “Consumer Control.” This illustrates movement of the data. Data from the PNO's environment, shown under PNO 2008, is made available in other environments; e.g., a social network environment 304. Consumer control 1109 defines what data the consumer wants to publish to social network 304. Consumer control 1109 also provides control regarding what data flows from the social network 304 back to the PNO 2008 (e.g., social graph data, such as when a consumer performs a check-in at a certain location; who the consumer is linked to; all of his or her friends; and the like—the consumer decides if PNO 2008 is allowed to see his or her friends, see photos in his or her photo album, when he or she checks in, and so on). If permitted, this data flows back from social network 304 to PNO 2008. Similarly, as discussed above, the consumer can elect to publish, for example, all restaurant transactions, in which case that data flows from PNO 2008 to social network 304.

The column under the social media site 304 represents the entire social network environment; whether it is a wall, timeline, or the like. Here, there is a native user interface (UI) 1103 physically within the social network environment. It is built with social network APIs. It appears to the user as a social network application when the user is using it in the social network; for example, checking boxes, clicking options, etc., to indicate the consumer's choices for what data flow is allowed in both directions. As seen at 1105, consumer services that may be offered include setup, account management, data controls, offer controls, and the like. Graph data 1107 is a non-limiting example of social networking data.

Consider the rightmost column under merchant 2004. If merchant 2004 wishes to sell something to consumer 302 at social media web site 304, the checkout process occurs with the merchant 2004 via the social media web site 304 using one of the payment devices from the wallet 1117 in the social media environment. Please note that the selected payment device may or may not have the same brand as that of the PNO; that is, if the PNO is MasterCard International Incorporated, the selected payment device may be a MasterCard card, a Visa card, a Discover card, and so on. The checkout page is shown at 1111 with the specific e-wallet checkout feature at 1113.

One link between this payment process and the process of PNO-SMSO data sharing discussed above is that the consumer may often see an offer he or she wants and click on it; this results in the consumer being directed to the merchant of record. The linkage between the offer and the merchant is depicted at 1115. Offer management services 1115 may correspond, for example, to web services or the like which upload offers to offer services 1119, assist in fulfillment of offers, and so on.

Consider the processes associated with merchant 2004 from a consumer's point of view. Suppose a consumer wants to purchase something from a merchant. In the social network context, it could be something in an on-line game such as a stronger shield, or a virtual tractor in a farming simulation social network game. The consumer selects the desired item from the merchant and proceeds to checkout page 1111. Instead of logging into the merchant's web site, the consumer uses the same user ID and password as for the social network 304 or the e-wallet cloud 1117. The consumer does not need another user ID and password; he or she simply clicks the “buy” button. Because the system already knows who the consumer is, it simply picks the appropriate default payment source from the e-wallet 1117 (an opportunity may also be afforded to the consumer to choose an alternate payment source instead). In some instances, the individual may be making the purchase because he or she received an offer from offer services 1119. Recall the above-discussed example of a purchaser of lumber who is given $20 off an electric drill if purchased today. This purchaser may click on the offer and go back to the corresponding merchant page in the social network environment. This purchaser may log on with the social network or e-wallet cloud user ID and password. The user selects the drill with the $20 off coupon. The user pays the remaining $10 (say the drill was $30 without the $20 coupon) using the default payment mechanism from the e-wallet (or an alternative). The user then obtains the drill at the discounted price based on the offer from offer services 1119.

It should be noted that the person of ordinary skill in the art will be familiar with e-wallets per se, and, given the teachings herein, will be able to adapt same for implementing one or more embodiments of the invention. Non-limiting examples of known e-wallets include the PayPal service (mark of PayPal subsidiary of eBay, Inc., San Jose, Calif., USA); the Checkout by Amazon service (mark of Amazon.com, Inc., Seattle, Wash., USA); and the Google Checkout service (mark of Google, Inc. Mountain View, Calif., USA).

FIG. 13 shows an exemplary software architecture diagram. The software may be executed at a switching node 3003 within a payment processing network discussed below in the recapitulation section. Interface sub-modules include merchant information sub-module 3009 which provides the merchant's name, chain, address, phone number, web site, and the like; social network logon interface 3011 to permit login access to the social network; transactional information interface 3013 (may have dual functionality including obtaining data and providing data to the site 304 via API, RSS feed, push or pull agents, or the like—can also be separated into a transaction information intake sub-module and a transaction information sharing sub-module); geo-location interface sub-module 3015 which provides coordinates of elements in the payment network, such as ATMs, terminals accepting contactless payments, and the like; and sub-module 3017 for obtaining consent and filtering preferences (what kind of information it is desired to share). In general, the interface sub-modules may implement, for example, APIs. Linking application module 3007, on top of the interface sub-modules, includes configuration and filtering logic; it culls through the transactions and merchant information and publishes the data to site 304 in accordance with the consumer's expressed desires. User interface 3019 may include, for example, a suitable GUI, and is discussed further below. For the avoidance of doubt, FIG. 13 depicts the exemplary software architecture diagram with the software executed at a switching node 3003 within a payment processing network that connects payers 3001 and payees 3005. This is a desirable location for the software. Nevertheless, one or more embodiments involve interaction between an operator of a payment network (e.g. operator of network within which switching node 3003 is located), entities which make payments with the payment network (e.g. payers 3001), and the operator of a social media site 304; that is, one or more method steps do not necessarily involve payees 3005.

### Recapitulation

Given the discussion thus far, it will be appreciated that, in general terms, an exemplary method, according to an aspect of the invention, includes the step of obtaining, by an operator of a payment network, transaction data from a plurality of entities which make payments with the payment network. The term payment network, as used herein, is intended to refer to an electronic payment network which connects, directly and/or indirectly, payers 3001 (and/or their banks or similar financial institutions) with payees 3005 (and/or their banks or similar financial institutions). The network shown in FIG. 2 is a non-limiting example; other non-limiting examples include automated clearing house/demand deposit payment networks, mobile telephone payment networks, e-commerce business allowing payments and money transfers to be made through the Internet, and the like (it should be noted that the primary purpose of the payment network may not be payment; for example, a mobile telephony network may offer payment network capability even though its primary purpose may be mobile telephony). In at least some instances, the transaction data is obtained at a switching node 3003 within the payment network, and is optionally saved in data warehouse 154.

A further step includes obtaining, by the operator of the payment network, a plurality of consents from the plurality of entities which make payments with the payment network (for the avoidance of doubt, some or all of the entities may consent; i.e., the number of consents may be less than or equal to the number of entities). The plurality of consents authorize the operator of the payment network to share at least a portion of the transaction data from the plurality of entities which make payments with the payment network with an operator of a social media site 304. This step can be carried out, for example, using a suitable user interface module 3019, broadly understood to include both direct and indirect user interfaces, for example, a web-based graphical user interface (GUI) of the payment network operator and/or wallet, interface with a social media site's GUI, a call center, or via paper-based mail with subsequent data entry via a clerk, optical character recognition, etc. In at least some instances, the consents are obtained at the switching node 3003 within the payment network, and are optionally saved in data warehouse 154.

A still further step includes making at least the aforementioned portion of the transaction data available to the operator of the social media site 304. This transaction data may be provided from the payment network operator, acquirers, issuers, processors, or indeed any internal or external entity. This step can be carried out, for example, via module 3013 which may include an application program interface (API) code segment, push or pull agents, an RSS feed, or the like.

Non-limiting exemplary embodiments have been presented herein where the entities which make payments with the payment network are cardholders and the payment network is a payment card type of payment network. It should be noted that cardholders may or may not have physical payment cards—they may have appropriately configured cell phones or the like in addition to, or in lieu of traditional cards, or may have payment-card type accounts with which no physical card is associated. Furthermore, in general, the entities which make payments with the payment network are not limited to cardholders and the payment network is not limited to a payment card type of payment network—indeed, as noted above, the term payment network, as used herein, is intended to refer to an electronic payment network which connects, directly and/or indirectly, payers 3001 (and/or their banks or similar financial institutions) with payees 3005 (and/or their banks or similar financial institutions). The network shown in FIG. 2 is a non-limiting example; other non-limiting examples include automated clearing house/demand deposit payment networks, mobile telephone payment networks, e-commerce business allowing payments and money transfers to be made through the Internet, and the like (it should be noted that the primary purpose of the payment network may not be payment; for example, a mobile telephony network may offer payment network capability even though its primary purpose may be mobile telephony).

In some cases, the obtaining of the consent includes obtaining the consent for the benefit of both the operator of the payment network and the operator of the social media site; for example, using module 3017, in conjunction with UI 3019 or a UI of the site 304 or the like.

In some instances, a further step includes obtaining, by the operator of the payment network, a first plurality of selections from the plurality of entities which make payments with the payment network. The plurality of selections specify, for each given one of the entities which make payments with the payment network, which given portion of the transaction data is to be shared with the operator of the social media site. This step can be carried out, for example, using module 3017, in conjunction with UI 3019 or a UI of the site 304 or the like. The selections may optionally be stored in data warehouse 154.

In some cases, a further step includes obtaining, by the operator of the payment network, a second plurality of selections from the plurality of entities which make payments with the payment network. The second plurality of selections set forth, for each given one of the entities which make payments with the payment network, how the given portions of the transaction data are to be displayed by the social media site. This step can be carried out, for example, using module 3017, in conjunction with UI 3019 or a UI of the site 304 or the like. The selections may optionally be stored in data warehouse 154.

As noted, in some cases, a further step includes refraining from sharing certain records in the transaction data even if authorized by the first plurality of selections. This step can be carried out, for example, using logic in application 3007; for example, based on one or more policies stored in data warehouse 154.

In some instances, a further step includes filtering the transaction data from the plurality of entities which make payments with the payment network, in accordance with the first and second pluralities of selections, to obtain the aforementioned portion of the transaction data which is to be sent to the operator of the social media site. This step can be carried out, for example, using logic in application 3007, based on the selections stored in data warehouse 154.

In some cases, a further step includes affording the plurality of entities which make payments with the payment network an opportunity to update the first and second pluralities of selections. This step can be carried out, for example, using module 3017, in conjunction with UI 3019 or a UI of the site 304 or the like. The updated selections may optionally be stored in data warehouse 154.

As noted elsewhere, the consents may be obtained in a number of different ways. For example, in some cases, the consents are obtained via enrollment at a web site of the operator of the payment network (e.g., using UI 3019 and module 3017). In other cases, the consents are obtained via enrollment at a web site of the operator of the social media site and made available to the operator of the payment network (e.g., using a UI of site 304, module 3017, and module 3011). In this latter case, non-limiting examples for obtaining the consents at the social media site include at a payments setting page of the social media site, at an “add payments” method page of the social media site, and/or at a timelines page of the social media site.

As noted, in some instances, the entities which make payments with the payment network are cardholders and the consents are obtained via enrollment at a web site of at least one issuer 2010 of card accounts associated with the plurality of cardholders and made available to the operator of the payment network.

Non-limiting examples of the aforementioned portion of the transaction data include transaction date, transaction brand, a social media identifier of a corresponding merchant, and a social media identifier of a corresponding one of the entities which make payments with the payment network.

In another aspect, in some cases, a further step includes generating a targeted advertisement based at least partially on the at least portion of the transaction data. Optionally, the targeted advertisement is further based on data from the social media site.

In some instances, at least a portion of the transaction data is initially obtained by a third party other than an operator of the payment network. In general, the transaction data feeds may be obtained from a variety of sources; in one or more embodiments, including third parties other than the payment network operator (issuers, acquirers, other data providers with itineraries, folio-level data, SKU-level data, and the like).

Typically, however, at least a portion of the transaction data is obtained directly by the operator of the payment network. In some cases, at least some of the transaction data is obtained by the operator of the payment network within an electronic wallet.

As noted, in at least some cases, the obtaining of the transaction data includes obtaining the transaction data at a switching node within the payment network. In some instances, a further step includes providing a system, wherein the system includes distinct software modules. Each of the distinct software modules is embodied on at least one non-transitory tangible computer readable recordable storage medium, and the distinct software modules include a user interface module 3019 and a social media site interface module (e.g., at least that portion of module 3013 which makes transaction data available to the site 304). In such cases, the obtaining of the plurality of consents is carried out by the user interface module 3019 executing on at least one hardware processor; and the at least portion of the transaction data is made available to the operator of the social media site by the social media site interface module executing on the at least one hardware processor.

It will thus be appreciated that one or more embodiments advantageously permit the surfacing of transactional data in a social network in a user-configurable way.

### System and Article of Manufacture Details

Embodiments of the invention can employ hardware and/or hardware and software aspects. Software includes but is not limited to firmware, resident software, microcode, etc. Software might be employed, for example, in connection with one or more of a terminal 122, 124, 125, 126; a reader 132; payment devices such as cards 102, 112; a host, server, and/or processing center 140, 142, 144 (optionally with data warehouse 154) of a merchant, issuer, acquirer, processor, or operator of a network 2008 operating according to a payment system standard (and/or specification), as well as in connection with the blocks and/or sub-blocks 3007-3017 of FIG. 13. Firmware might be employed, for example, in connection with payment devices such as cards 102, 112 and reader 132. Firmware provides a number of basic functions (e.g., display, print, accept keystrokes) that in themselves do not provide the final end-use application, but rather are building blocks; software links the building blocks together to deliver a usable solution.

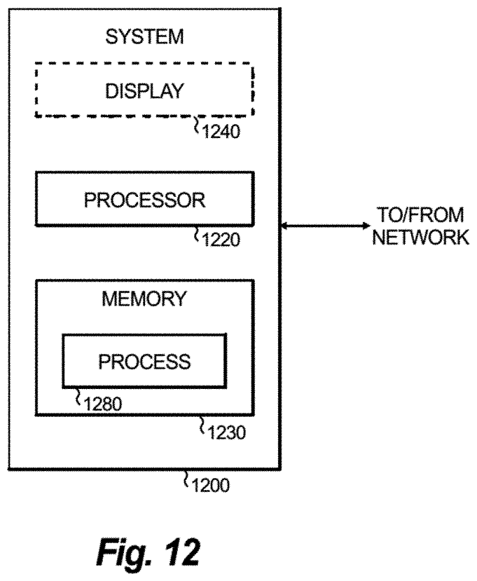

FIG. 12 is a block diagram of a system 1200 that can implement part or all of one or more aspects or processes of the invention. As shown in FIG. 12, memory 1230 configures the processor 1220 (which could correspond, e.g., to processor portions 106, 116, 130; processors of remote hosts in centers 140, 142, 144; processors of servers implementing blocks and/or sub-blocks 3007-3017 of FIG. 13, and the like) to implement one or more aspects of the methods, steps, and functions disclosed herein (collectively, shown as process 1280 in FIG. 12). Different method steps can be performed by different processors. The memory 1230 could be distributed or local and the processor 1220 could be distributed or singular. The memory 1230 could be implemented as an electrical, magnetic or optical memory, or any combination of these or other types of storage devices (including memory portions as described above with respect to cards 102, 112). It should be noted that if distributed processors are employed, each distributed processor that makes up processor 1220 generally contains its own addressable memory space. It should also be noted that some or all of computer system 1200 can be incorporated into an application-specific or general-use integrated circuit. For example, one or more method steps could be implemented in hardware in an ASIC rather than using firmware. Display 1240 is representative of a variety of possible input/output devices (e.g., displays, mice, keyboards, and the like).

The notation “to/from network” is indicative of a variety of possible network interface devices.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a SMSO's infrastructure and another device could be a physical memory media associated with a processing center of a PNO. As used herein, a tangible computer-readable recordable storage medium is intended to encompass a non-transitory recordable medium, examples of which are set forth above, but is not intended to encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on elements 140, 142, 144, 3003, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, 140, 142, 144, and blocks and/or sub-blocks 3007-3017 of FIG. 13 can make use of computer technology with appropriate instructions to implement method steps described herein. The various platforms can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 1200 as shown in FIG. 12) running a server program. It will be understood that such a physical server may or may not include a display, keyboard, or other input/output components. A “host” includes a physical data processing system (for example, system 1200 as shown in FIG. 12) running an appropriate program. It will be understood that such a host may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. In one or more embodiments, the modules include modules to implement the blocks and/or sub-blocks 3007-3017 of FIG. 13 (data warehouse 154 may also include software and appropriate physical persistent storage). The blocks may be implemented by the software modules together with corresponding memories and one or more processors. The modules can run, for example on one or more hardware processors of one or more servers; in general, all could run on the same server, each could run on a separate server, and so on. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Computers discussed herein can be interconnected, for example, by one or more of network 138, 2008, another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, JavaScript or other ECMAScript based scripting languages, and the like (an exemplary and non-limiting list), and can also make use of, for example, Extensible Markup Language (XML), JSON, name/value pairs, known application programs such as relational database applications, spreadsheets, and the like. As noted, in some instances, APIs can be implemented in third generation languages such as C++, Perl, and JSON. The computers can be programmed to implement the logic depicted in the flow charts and other figures. At least some messages, in at least some instances, can be in accordance with ISO 8583.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. (canceled)

2. A method of operating a payment network disposed between at least one issuer and at least one acquirer, said method comprising the steps of:
providing a switching node within said payment network connecting said at least one issuer and at least one acquirer;
obtaining, by said switching node, transaction data from within said payment network, wherein said transaction data is stored in a data warehouse connected to said switching node, and where said transaction data corresponds to interactions of an entity which makes payments with said payment network via said at least one acquirer;
providing an interface using a user interface module of said switching node for consumer control of said transaction data stored in said data warehouse for obtaining, by said data warehouse of said payment network, a consent authorizing an operator of said payment network to share a portion of said transaction data associated with said entity with an operator of a social media site, said social media site operating in a second network different than said payment network; and
using said consent obtained through said interface to filter said transaction data in socializing said portion of said transaction data stored in said data warehouse through said social media site, wherein said portion of said transaction data is determined by at least one hardware processor of said switching node by filtering said transaction data associated with said entity using said consent.

3. The method of claim 2, further comprising obtaining, by said operator of said payment network, a first plurality of selections from said entity which makes payments with said payment network, wherein said first plurality of selections specify said portion of said transaction data associated with said entity socialized through said social media site, and wherein said portion of said transaction data is determined by said at least one hardware processor of said payment network using said first plurality of selections.

4. The method of claim 3, further comprising obtaining, by said operator of said payment network, a second plurality of selections from said entity which makes payments with said payment network, said second plurality of selections setting forth, for said entity which makes payments with said payment network, how said portions of said transaction data are to be displayed by said social media site.

5. The method of claim 3, further comprising refraining from sharing at least one record in said transaction data that has been authorized using said first plurality of selections.

6. The method of claim 2, further comprising obtaining, by said operator of said payment network, a first plurality of selections from said entity which makes payments with said payment network, wherein said filtering of said transaction data is performed by category in accordance with said first plurality of selections, to obtain said portion of said transaction data socialized through said social media site, wherein at least one of said first plurality of selections specifies at least one category of said transaction data for socializing.

7. The method of claim 4, further comprising affording said entity which makes payments with said payment network an opportunity to update said first and second pluralities of selections.

8. The method of claim 2, wherein said consent is obtained via enrollment at a web site of said operator of said payment network prior to socializing said portion of said transaction data.

9. The method of claim 2, wherein said consent is obtained via enrollment at a web site of said operator of said social media site and made available to said operator of said payment network.

10. The method of claim 9, wherein said consent is obtained via an electronic wallet containing a plurality of payment accounts of said entity and is a control on said transaction data stored in said data warehouse.

11. The method of claim 10, wherein said payments accounts are issued by said at least one issuer.

12. The method of claim 2, wherein said consent is obtained from said entity via enrollment at a web site of said at least one issuer of payments accounts associated with said entity, and wherein said consent is made available to said operator of said payment network.

13. The method of claim 2, wherein said transaction data comprises transaction date, transaction brand, a social media identifier of a corresponding merchant, and a social media identifier of said entity which makes payments with said payment network.

14. The method of claim 2, further comprising generating a targeted advertisement based on said portion of said transaction data.

15. The method of claim 2, wherein said transaction data is obtained directly by said operator of said payment network.

16. The method of claim 2, wherein said portion of said transaction data is obtained by said operator of said payment network within an electronic wallet.

17. The method of claim 2, wherein said obtaining of said transaction data comprises obtaining said transaction data at said switching node within said payment network;
further comprising providing a system, wherein said system comprises distinct software modules, each of said distinct software modules being embodied on at least one non-transitory tangible computer readable recordable storage medium, and wherein said distinct software modules comprise said user interface module and a social media site interface module;
wherein:
said obtaining of said consent is carried out by said user interface module executing on said at least one hardware processor; and
said portion of said transaction data is made available to said operator of said social media site by said social media site interface module executing on said at least one hardware processor.

18. A method of operating a payment network disposed between at least one issuer and at least one acquirer, said method comprising the steps of:
providing a switching node within said payment network connecting said at least one issuer and at least one acquirer;
obtaining, by said switching node, transaction data from within said payment network, wherein said transaction data is stored in a data warehouse connected to said switching node, and said transaction data corresponds to interactions of an entity which makes payments with said payment network via said at least one acquirer;
obtaining, by said payment network, a consent authorizing an operator of said payment network to publish a portion of said transaction data associated with said entity to a social media site, said social media site operating in a second network different than said payment network, wherein said consent is obtained via an electronic wallet containing a plurality of payment accounts of said entity and is a control on said transaction data stored in said data warehouse; and
filtering said transaction data, using said consent, prior to publishing said portion of said transaction data stored in said data warehouse to said social media site, wherein said portion of said transaction data is determined by at least one hardware processor of said switching node by filtering said transaction data associated with said entity using said consent, and wherein said publishing facilitates socialization of said portion of said transaction data via said social media site.

19. The method of claim 18, further comprising publishing said portion of said transaction data to said social media site via one of said first network and said second network.

20. The method of claim 18, further comprising restricting, using a policy of said payment network, said publication of at least one transaction of said portion of said transaction data for which said consent has been obtained.
